(19) United States
(12) Patent Application Publication
(10) Pub. No.: US 2007/0047925 A1
(43) Pub. Date: Mar. 1, 2007

(54) Playback apparatus and playback method

(75) Inventor: Katsuhiko Araki, Hino-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/502,325

(22) Filed: Aug. 9, 2006

(30) Foreign Application Priority Data
Aug. 31, 2005 (JP) 2005-252242

(51) Int. Cl. H04N 5/00

(52) U.S. Cl. 386/125

(57) ABSTRACT

According to one embodiment, there is provided a playback apparatus capable of playing back moving picture data from a recording disc of a two-layer structure including a first recording layer storing a moving picture data item having a first resolution and a second recording layer storing a moving picture data item having a second resolution. The playback apparatus includes a battery to drive the playback apparatus and a processor to perform control of switching between playback of the moving picture data item stored in the first recording layer and playback of the moving picture data item stored in the second recording layer based on an amount of charge remaining in the battery.

### CROSS-REFERENCE TO RELATED APPLICATIONS

This application is based upon and claims the benefit of priority from Japanese Patent Application No. 2005-252242, filed Aug. 31, 2005, the entire contents of which are incorporated herein by reference.

### BACKGROUND

1. Field

One embodiment of the invention relates to a playback apparatus, such as an audio/video player, which can be driven by a battery and plays back moving picture data, and also to a playback method applied to the apparatus.

2. Description of the Related Art

In recent years, playback apparatuses (e.g., DVD players) of portable type have been developed. The playback apparatuses of portable type are driven by batteries. In a battery-driven playback apparatus, the amount of charge in the battery may be reduced during playback of moving picture contents, in which case the contents cannot be played back to the end. Therefore, the portable playback apparatus needs a function to extend the battery lifetime.

Jpn. Pat. Appln. KOKAI Publication No. 2001-319407 discloses a music playback apparatus, which plays back a plurality of music data files containing the same music data compressed at different compression rates. The music playback apparatus has a plurality of operation modes of different power consumptions. In a power saving mode, the music playback apparatus plays back a music data file for a low power consumption (data of a low sound quality compressed at a high compression rate). As a result, the battery lifetime can be extended.

Further, in the music playback apparatus disclosed in the above document, to reduce power consumption, the internal clock of a central processing unit (CPU) is reduced or stopped in the power saving mode.

However, if the clock control in the CPU is executed during playback of moving picture data, the processing speed of the CPU may be lowered, resulting in frame omission or the like. In this case, the moving picture data may not be played back smoothly.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an exterior of a playback apparatus according to an embodiment of the invention;

FIG. 2 is an exemplary block diagram showing an example of the system configuration of the playback apparatus shown in FIG. 1;

FIG. 3 is an exemplary block diagram for explaining a function configuration of a system controlling processor provided in the playback apparatus shown in FIG. 1;

FIG. 4 is an exemplary diagram for explaining a first example of a contents list produced by the playback apparatus shown in FIG. 1;

FIG. 5 is an exemplary diagram for explaining an example of power consumption information defining an amount of power consumption for each of the types of format set in advance by the playback apparatus shown in FIG. 1;

FIG. 6 is an exemplary first flowchart for explaining a first example of the procedures of playback processing executed by the playback apparatus shown in FIG. 1;

FIG. 7 is an exemplary second flowchart for explaining a first example of the procedures of playback processing executed by the playback apparatus shown in FIG. 1;

FIG. 8 is an exemplary third flowchart for explaining a first example of the procedures of playback processing executed by the playback apparatus shown in FIG. 1;

FIG. 9 is an exemplary diagram showing an example of a sectional structure of a recording medium in a second example of playback processing executed by the playback apparatus shown in FIG. 1;

FIG. 10 is an exemplary diagram for explaining a second example of a contents list produced by the playback apparatus shown in FIG. 1; and

FIG. 11 is an exemplary flowchart for explaining a second example of the procedures of playback processing executed by the playback apparatus shown in FIG. 1.

### DETAILED DESCRIPTION

Various embodiments according to the invention will be described hereinafter with reference to the accompanying drawings. In general, according to one embodiment of the invention, there is provided a playback apparatus capable of playing back moving picture data from a recording disc of a two-layer structure including a first recording layer storing a moving picture data item having a first resolution and a second recording layer storing a moving picture data item having a second resolution. The playback apparatus includes a battery to drive the playback apparatus and a processor to perform control of switching between playback of the moving picture data item stored in the first recording layer and playback of the moving picture data item stored in the second recording layer based on an amount of charge remaining in the battery.

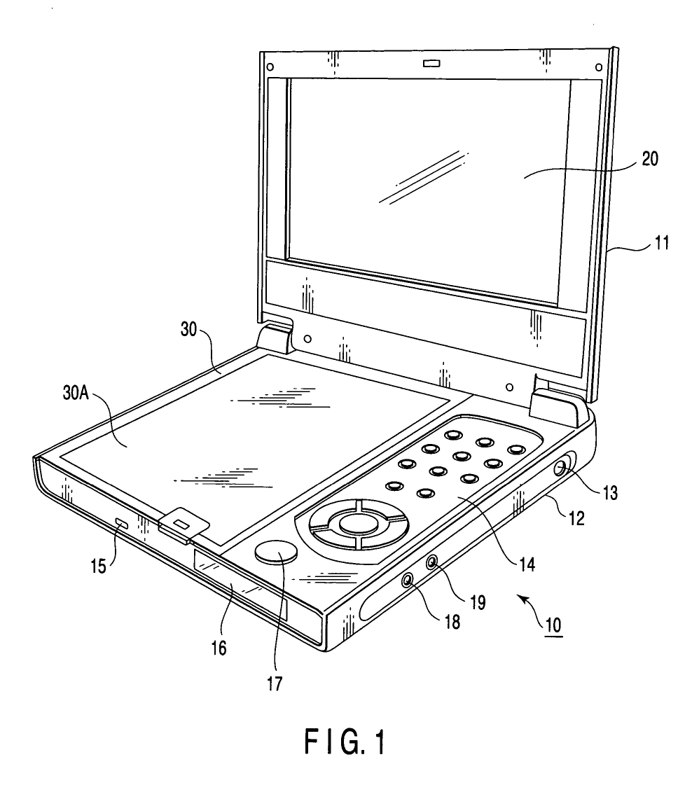

First, the configuration of a playback apparatus according to an embodiment of the invention will be described with reference to FIGS. 1 to 3. The playback apparatus is implemented as a portable audio/video (AV) player 10, which is, for example, configured to be driven by a battery and plays back moving picture contents stored in a recording medium. The recording medium stores a plurality of moving picture data items having different formats. The moving picture data items, which correspond to the same video title, are provided from the same image source. The type of format is determined by the combination of a resolution, a bit rate and a compressed format. The resolution represents sizes (a size in the horizontal direction and a size in the vertical direction) of each of a plurality of frames constituting a moving picture data item. The bit rate represents the amount of data transmitted per unit time. The compressed format represents a compression coded format of a moving picture data item.

When a video title is played back, the AV player 10 chooses one of a plurality of moving picture items corresponding to the video title on the basis of the amount of charge remaining in the battery and power consumption information. More specifically, the AV player 10 chooses a moving picture data item having a format, which allows the AV player to play back the video title to the end, or a moving picture data item having a format, which allows the AV player to continuously playback moving pictures for a longer time. The power consumption information is determined in advance for each of the types of format.

FIG. 1 is a perspective view of the AV player 10, showing a state in which a display unit 11 is open. The AV player 10 comprises the display unit 11 and an AV player main body 12. The display unit 11 incorporates a display device comprising a liquid crystal display (LCD) panel 20. The display screen of the LCD panel 20 is located substantially in the central portion of the display unit 11.

The display unit 11 is attached to the AV player main body 12. It is rotatable relative to the AV player main body 12 between an open position in which the upper surface of the AV player main body 12 is exposed and a closed position in which the upper surface of the AV player main body 12 is covered. The AV player main body 12 has a thin box-shaped casing. The casing incorporates an optical disc drive 30. An operation switch group 14, a cover portion 30A covering the optical disc drive 30 and a button switch 17 to open the cover portion 30A are provided on the upper surface of the casing. A power button switch 13 to power on the AV player 10, an analog image output portion 18 and an analog sound output portion 19 are provided on a side surface of the AV player main body 12.

The operation switch group 14 includes a button switch to play back and stoop moving picture data, a fast-forward button switch to fast forward moving picture data, a fast-reverse button switch to fast reverse moving picture data, etc. The optical disc drive 30 drives a recording medium, such as a digital versatile disc (DVD) and a compact disc (CD), and read moving picture image from the recording medium. The analog image output portion 18 is an output portion to externally output image signals. The analog sound output portion 19 is an output portion to externally output sound signals. An infrared light receiving portion 15 receives an operation request transmitted from an infrared remote control unit. A display panel 16 displays, for example, the video title name stored in the recording medium currently loaded in the optical disc drive 30 and the playback time of the video title.

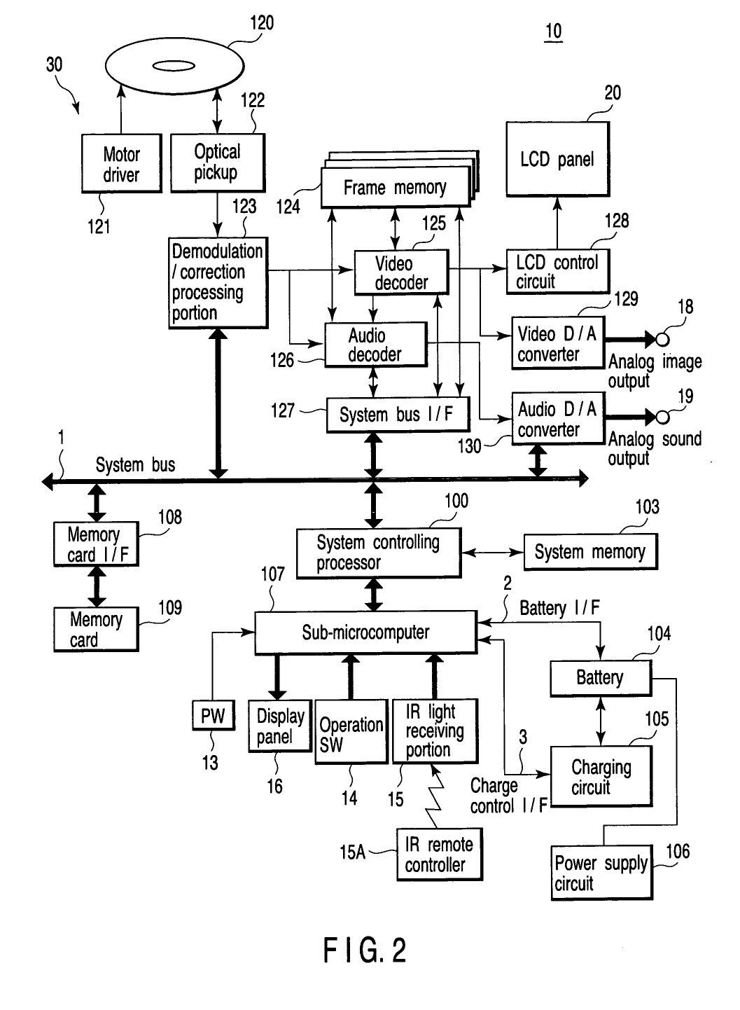

The system configuration of the AV player 10 will now be described with reference to FIG. 2.

The AV player 10 comprises a system controlling processor 100, a system memory 103, a battery 104, a charging circuit 105, a power supply circuit 106, a sub-microcomputer 107, a memory card interface 108, a motor driver 121, an optical pickup 122, a demodulation/correction processing portion 123, a frame memory 124, a video decoder 125, an audio decoder 126, a system bus interface 127, an LCD control circuit 128, a video D/A converter 129, an audio D/A converter 130, etc.

The system controlling processor 100 controls each of the components of the AV player 10. The system controlling processor 100 also reads power consumption information from the system memory 103. Further, the system controlling processor 100 has a function of performing communication with the sub-microcomputer 107. The system controlling processor 100 is connected to a system bus 1.

The sub-microcomputer 107 receives an operation request input through the operation switch group 14, the infrared light receiving portion 15, etc., and notifies the system controlling processor 100 of the received operation request. The battery 104 is connected to the sub-microcomputer 107 via a battery interface 2. The charging circuit 105 is connected to the sub-microcomputer 107 via a charge control interface 3. The sub-microcomputer 107 detects the amount of charge remaining in the battery 104 through the battery interface 2, and notifies the system controlling processor 100 of the detected amount of charge remaining in the battery 104. The charging circuit 105 and the power supply circuit 106 are connected to the battery 104. The charging circuit 105 supplies to the battery 104 the electric power externally supplied through an AC adapter or the like connected to the AV player 10. Thus, the charging circuit 105 charges the battery 104. The power supply circuit 106 generates power to be supplied to the components of the AV player 10 from power of the battery 104, when the user depresses the power button switch 13. A memory card 109 is connected to the system bus 1 via the memory card interface 108. The memory card 109 functions as a storage device for storing data or the like.

The optical disc drive 30 comprises the motor driver 121 and the optical pickup 122. The motor driver 121 rotates a recording medium 120. The optical pickup 122 radiates a laser beam onto the recording medium 120 and acquires an audio/video (AV) signal from the reflected laser beam. The demodulation/correction processing portion 123 demodulates the AV signal acquired by the optical pickup 12, and corrects the demodulated AV signal. Further, the demodulation/correction processing portion 123 separates the demodulated and corrected AV signal into moving picture data and sound data. Then, it transmits the moving picture data to the video decoder 125, and the sound data to the audio decoder 126. The video decoder 125 decodes the moving picture data, and transmits the decoded moving picture data to the LCD control circuit 128 and the video D/A converter 129. The LCD control circuit 128 generates a display signal to display the moving picture data transmitted from the video decoder 125 in the LCD panel 20. The video D/A converter 129 externally outputs the moving picture data transmitted from the video decoder 125. The audio decoder 126 decodes sound data, and outputs the decoded sound data via the audio D/A converter 130 to the outside or to a speaker provided in the AV player 10.

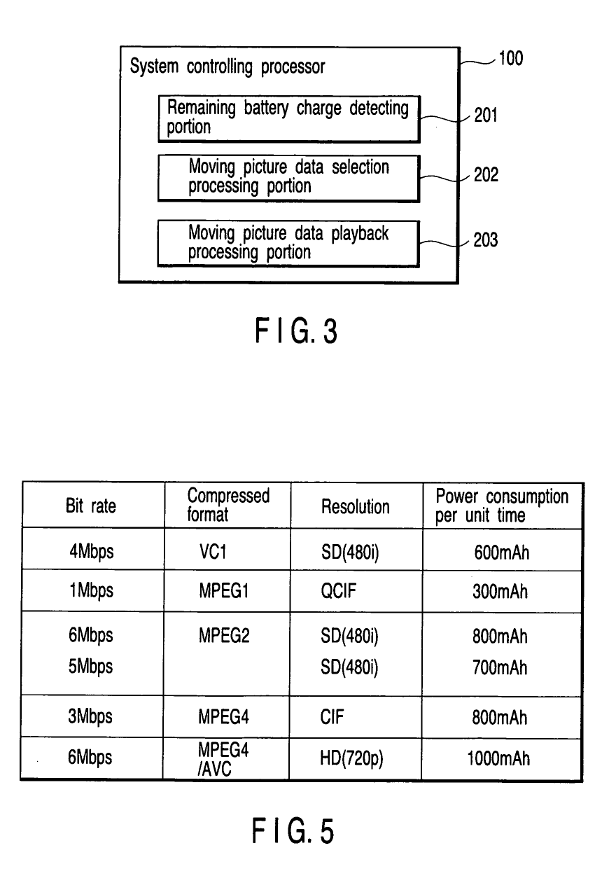

Functions of the system controlling processor 100 will now be described with reference to FIG. 3. The system controlling processor 100 comprises a remaining battery charge detecting portion 201, a moving picture data selection processing portion 202 and a moving picture data playback processing portion 203. The remaining battery charge detecting portion 201 executes a process of detecting the amount of charge remaining in the battery 104. The moving picture data selection processing portion 202 generates a contents list based on the types of format of the respective moving picture data stored in the recording medium 120 and the amount of charge remaining in the battery 104 detected by the remaining battery charge detecting portion 201. The contents list indicates an estimated playback time, in which each moving picture data item can be played back by the power supplied from the battery 104 and whether the data item can be played back to the end. Based on the contents list, the moving picture data selection processing portion 202 selects a moving picture data item to be played back from a plurality of moving picture data items corresponding to the video title to be played back. More specifically, if the amount of charge remaining in the battery is greater than a predetermined threshold value, the moving picture data selection processing portion 202 selects a moving picture data item of the highest image quality (for example, a moving picture data item having the highest resolution) from all the moving picture data items corresponding to the video title to be played back. On the other hand, if the amount of charge remaining in the battery is equal to or smaller than a predetermined threshold value, the moving picture data selection processing portion 202 selects a moving picture data item of the longest playback time (for example, a moving picture data item having the lowest resolution) from all the moving picture data items corresponding to the video title to be played back. In general, more power is consumed in a case of playing back a moving picture data item having a higher resolution than in a case of playing back a picture data item having a lower resolution. Further, in general, a moving picture data item, which is compressed by a compression coded format at a higher compression rate and which has a higher resolution, consumes more power in proportion to the amount of decode processing to play back the moving picture data item. The moving picture data playback processing portion 203 plays back the moving picture data item selected by the moving picture data selection processing portion 202.

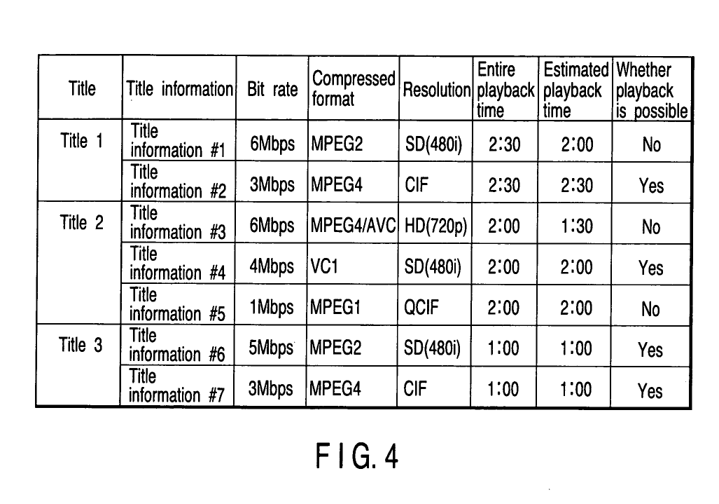

An example of the contents list will be described below with reference to FIG. 4. As shown in FIG. 4, the contents list includes items “title”, “title information”, “bit rate”, “compressed format”, “resolution”, “entire playback time”, “estimated playback time” and “whether playback is possible”, for each of the moving picture data items. The item “title” indicates a title of, for example, a moving picture data item. The item “title information” indicates an identifier to identify a moving picture data item. The item “bit rate” indicates a bit rate of a moving picture data item. The item “compressed format” indicates a compression coded format of a moving picture data item. The item “resolution” indicates resolution of a moving picture data item. Examples of “resolution” are “SD (480i)” indicative of the resolution of an interlace image of SD (Standard Definition) standard and “HD (720p)” indicative of the resolution of a progressive image of HD (High Definition) standard. The item “entire playback time” indicates the length of playback time from the beginning to the end of a moving picture data item. The item “estimated playback time” indicates the length of playback time, in which the moving picture data item can be played back by the power from the battery 104. The item “whether playback is possible” indicates whether the moving picture data item can be played back from the beginning to the end by the power from the battery 104.

The recording medium 120 stores two moving picture data items corresponding to a video title 1, three moving picture data items corresponding to a video title 2 and two moving picture data items corresponding to a video title 3. The two moving picture data items corresponding to the video title 1 are a moving picture data item corresponding to title information #1 and a moving picture data item corresponding to title information #2.

The three moving picture data items corresponding to the video title 2 are a moving picture data item corresponding to title information #3, a moving picture data item corresponding to title information #4 and a moving picture data item corresponding to title information #5. The two moving picture data items corresponding to the video title 3 are a moving picture data item corresponding to title information #6 and a moving picture data item corresponding to title information #7.

The two moving picture data items corresponding to the video title 1 (the moving picture data item corresponding to title information #1 and the moving picture data item corresponding to title information #2) are structured from one image source, the entire playback time of which is two hours and thirty minutes. The three moving picture data items corresponding to the video title 2 (the moving picture data item corresponding to title information #3, the moving picture data item corresponding to title information #4 and the moving picture data item corresponding to title information #5) are structured from one image source, the entire playback time of which is two hours. The two moving picture data items corresponding to the video title 3 (the moving picture data item corresponding to title information #6 and the moving picture data item corresponding to title information #7) are structured from one image source, entire playback time of which is an hour.

For example, the image picture data item corresponding to the title information #1 is an image picture data item having a type of format defined by the combination of the bit rate of 6 Mbps, the compressed format of MPEG2 and the resolution of SD (480i) standard. As for the moving picture data item corresponding to the title information #1, entire playback time is two hours and thirty minutes, whereas the estimated playback time is two hours. Therefore, the item “whether playback is possible” of the moving picture data item corresponding to the title information #1 is assigned the mark “No”, representing that it is not possible to play back the moving picture data corresponding to the video title 1 to the end.

For example, the image picture data item corresponding to the title information #2 is an image picture data item having a type of format defined by the combination of the bit rate of 3 Mbps, the compressed format of MPEG4 and the resolution of common intermediate format (CIF) standard. As for the moving picture data item corresponding to the title information #2, entire playback time is two hours and thirty minutes, and the estimated playback time is also two hours and thirty minutes. Therefore, the item “whether playback is possible” of the moving picture data item corresponding to the title information #1 is assigned the mark “Yes”, representing that it is possible to play back the moving picture data corresponding to the video title 1 to the end.

Next, an example of power consumption information will be described with reference to FIG. 5. As shown in FIG. 5, power consumption information indicates power consumption per unit time for each of the types of format of moving picture data.

Assuming that a moving picture data item has a type of format defined by the combination of the bit rate of 4 Mbps, the compressed format of VC1 (Video Coding) and the resolution of SD (480i) standard, the power consumption per unit time is 600 mA. The power consumption information is prestored in, for example, the system memory 103. Actually, the power consumption per unit time is calculated in consideration of not only the type of format but also operation power for the AV player 10. The operation power for the AV player 10 includes power consumed by the LCD panel 20 of the AV player 10, which depends on the degree of contrast of the panel, and power consumed by the speaker mounted in the AV player 10, which depends on the volume of sound output from the speaker.

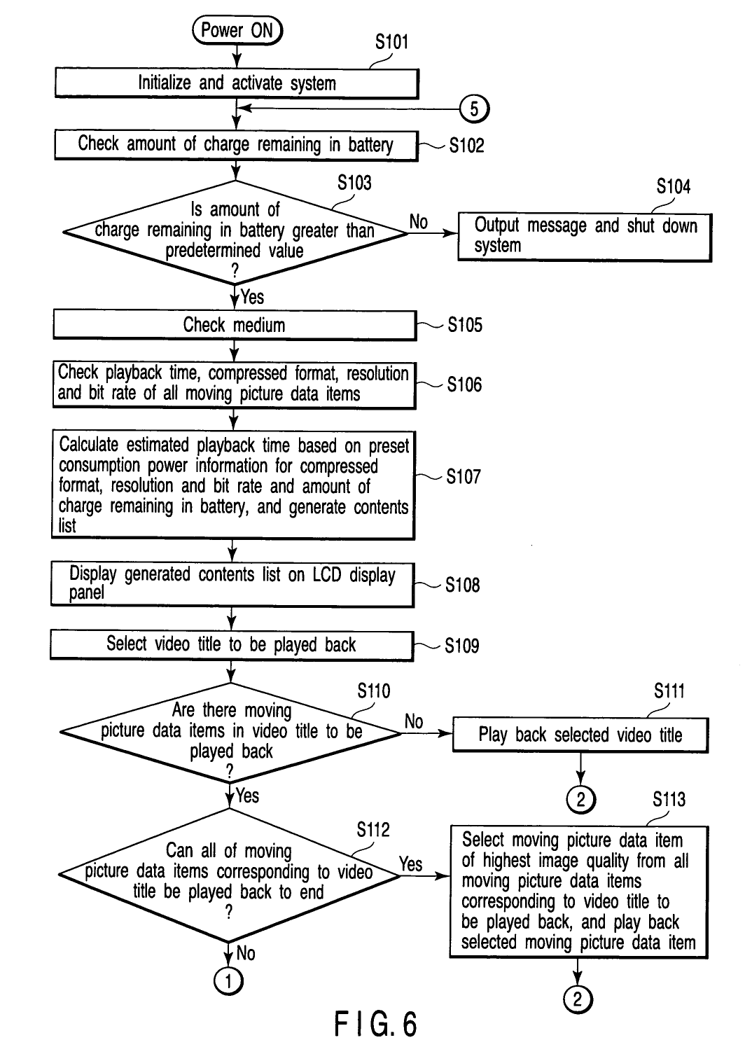

A first example of playback processing in this embodiment will be described with reference to the flowcharts shown in FIGS. 6 to 8. The playback processing is executed by the system controlling processor 100. When the power button switch 13 is depressed, the AV player 10 is powered on and the components of the AV player are initialized (block S101). The system controlling processor 100 checks the amount of charge remaining in the battery 104, and determines whether the amount of charge remaining in the battery is greater than a predetermined value (blocks S102 and S103). If the amount of charge remaining in the battery 104 is equal to or smaller than the predetermined value (NO in block S103), the system controlling processor 100 displays a message indicative of battery exhaustion on the LCD panel 20, and shuts down the AV player 10 (block S104).

If the amount of charge remaining in the battery 104 is determined to be greater than the predetermined value (YES in block S103), the system controlling processor 100 checks the entire playback time and a type of format (bit rate, resolution and compressed format) of each of the moving picture data items stored in the recording medium 120 inserted in the optical disc drive 30 (blocks S105 and S106). In the case of a moving picture data item having a compressed format defined by MEPG2, in the block S106, the system controlling processor 100 can check the type of format by referring to a sequence header of the moving picture data item. The system controlling processor 100 can also check the video title name of a moving picture data item by checking index data added by the user to the original video title name.

The system controlling processor 100 calculates an estimated playback time of each moving picture data item based on the consumption power information, the checked type of format and the checked amount of charge remaining in the battery, and generates a contents list based on the calculation results (block S107).

The system controlling processor 100 displays the generated contents list on the LCD panel 20 (block S108). In the block S108, the system controlling processor 100 displays the estimated playback time and whether the playback is possible with respect to a moving picture data item corresponding to each of the video titles on a on-screen display or the display panel 16 in accordance with display instructions from the remote control unit. The on-screen display is a function of overlaying display information on the LCD panel 20.

Then, the system controlling processor 100 select a video title to be played back from a plurality of video titles (block S109). In the block S109, if the operation mode of the AV player 10 is an automatic selection mode, the system controlling processor 100 automatically selects the video title to be played back from the plurality of video titles. If the operation mode of the AV player 10 is a user selection mode, the system controlling processor 100 causes the LCD panel 20 to display a screen to select the video title to be played back from the plurality of video titles. The user can select the video title to be played back by operating the operation switch group 14.

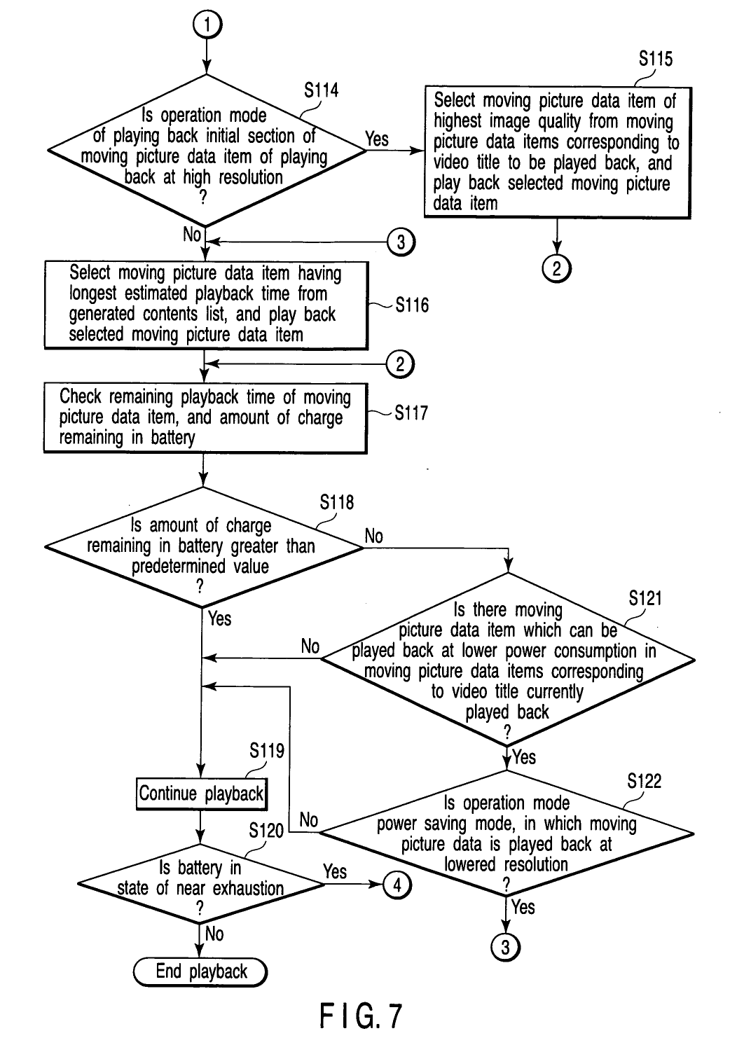

Thereafter, the system controlling processor 100 determines whether there are a plurality of moving picture data items in the video title to be played back (block S110). If there are a plurality of moving picture data items corresponding to the video title to be played back (YES in block S110), the system controlling processor 100 determines, based on the amount of charge currently remaining in the battery and the contents list, whether the condition “all of the plurality of moving picture data items corresponding to the video title to be played back can be played back to the end” is satisfied or not (block S112). If the condition “all of the plurality of moving picture data items corresponding to the video title to be played back can be played back to the end” is not satisfied (NO in block 112), the system controlling processor 100 determines whether the current operation mode of the AV player 10 is “a high-quality playback mode”, in which an initial section of the moving picture data item corresponding to the video title to be played back is played back at the highest resolution (block S114 in FIG. 7).

If it is determined that the operation mode of the AV player 10 is not “the high-quality playback mode” (NO in block 114), the system controlling processor 100 selects a moving picture data item having the longest estimated playback time from the plurality of moving picture data items corresponding to the video title to be played back, and plays back the selected moving picture data item (block S116).

Next, the system controlling processor 100 checks the remaining playback time of the video title under playback, and the amount of charge remaining in the battery 104 (block S117). The remaining playback time is a time calculated by subtracting the time corresponding to the part of the item that has already been played back from the entire playback time of the moving picture data item corresponding to the video title currently under playback. In the block S117, the system controlling processor 100 updates the estimated playback time and the information on whether the playback is possible or not for each of the plurality of moving picture data items corresponding to the video title under playback in accordance with the results of check of the remaining playback time and the amount of charge remaining in the battery 104. The system controlling processor 100 determines in the block S117 whether the amount of charge remaining in the battery 104 is greater than the predetermined value, that is, whether the charge remaining in the battery is sufficient for playing back the moving picture data item currently under playback to the end (block S118). If it is determined that the amount of charge remaining in the battery is greater than the predetermined value (YES in block S118), the system controlling processor 110 continues the playback of the video title currently under playback (block S119). The system controlling processor 110 checks the amount of charge remaining in the battery 104, and determines whether the battery is in a state of near exhaustion, that is, whether the charge remaining in the battery 104 is extraordinarily little (block S120). The state in which the charge remaining in the battery 104 is extraordinarily little is, for example, a state where there is substantially no charge remaining in the battery 104, in which state the AV player 10 cannot continue playing back moving picture data.

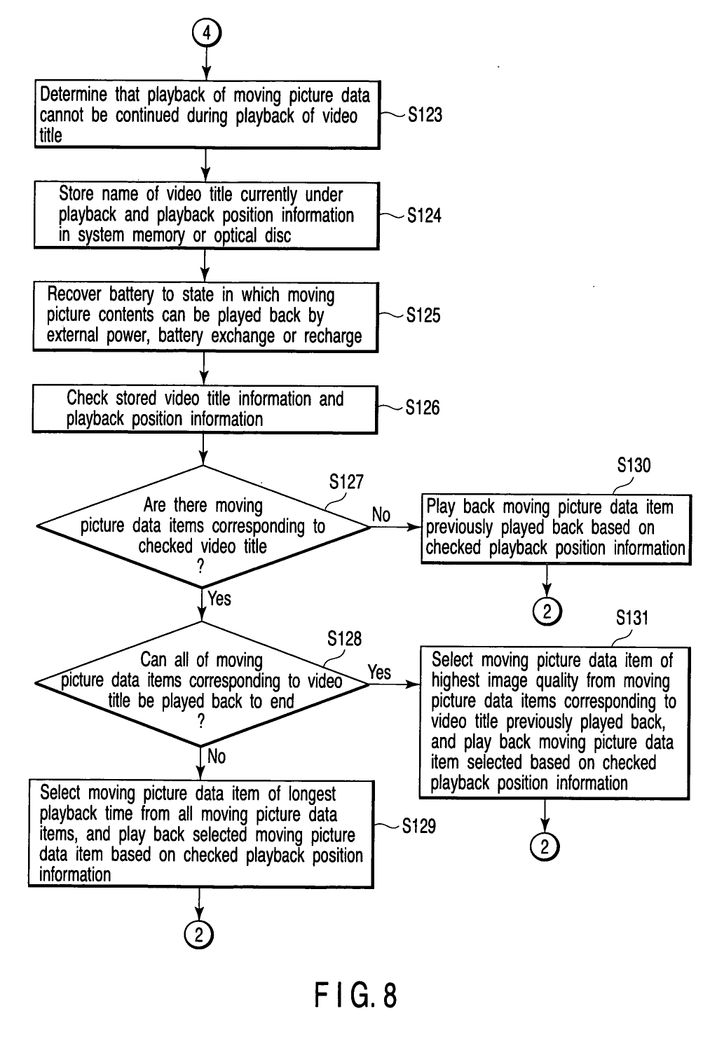

If the system controlling processor 100 determines that the charge remaining in the battery 104 is extraordinarily little (YES in the block S120), it determines that playback of the moving picture data cannot be continued (block S123 in FIG. 8). Then, the system controlling processor 100 stores the name of the video title currently under playback, the playback position information indicative of the currently played-back position (the position of the chapter currently played back or the time elapsed from the start of the playback process) in the system memory 103, a DVD-RAM, or the like (block S124). For example, when power is supplied to the AV player 10 from an external power source, when the battery is exchanged for a new one or when the battery 104 is recharged to a state in which moving picture contents can be played back, the system controlling processor 100 checks the video title name and the playback position information stored in the recording medium, such as the system memory 103 or the DVD-RAM or the like (blocks S125 and S126). The system controlling processor 100 determines whether there are a plurality of moving picture data items corresponding to the video title designated by the stored video title name (block S127). If the system controlling processor 100 determines that there are a plurality of moving picture data items corresponding to the video title designated by the video title name (YES in block S127), it determines whether the condition “all of the plurality of moving picture data items corresponding to the video title to be played back can be played back to the end” is satisfied or not (block S128). If the system controlling processor 100 determines that the condition “all of the plurality of moving picture data items corresponding to the video title to be played back can be played back to the end” is not satisfied (NO in block S128), it selects a moving picture data item of the longest playback time from all the moving picture data items corresponding to the video title to be played back. The system controlling processor 100 plays back the selected moving picture data item based on the checked playback position information (block S129).

If the system controlling processor 100 determines that there are not a plurality of moving picture data items in the moving picture data corresponding to the checked video title (NO in block S127), it plays back the moving picture data item that was previously played back from the playback position designated by the stored playback position information (block S130). Then, the system controlling processor 100 proceeds to the process of the block S117.

If the system controlling processor 100 determines that the condition “all of the plurality of moving picture data items corresponding to the video title to be played back can be played back to the end” is satisfied (YES in block S128), it selects a moving picture data item of the highest image quality (for example, a moving picture data item having the highest resolution) from all the moving picture data items corresponding to the video title to be played back. Then, the system controlling processor 100 plays back the moving picture data item selected on the basis of the checked playback position information (block S131). Thereafter, the system controlling processor 100 proceeds to the process of the block S117.

If the system controlling processor 100 determines that there are not a plurality of moving picture data items corresponding to the video title to be played back (NO in block S110), it plays back the moving picture data item corresponding to the selected video title (block S111). After executing the block S111, the system controlling processor 100 proceeds to the block S117.

If the condition “all of the plurality of moving picture data items corresponding to the video title to be played back can be played back to the end” is satisfied (YES in block 112), the system controlling processor 100 selects a moving picture data item of the highest image quality (for example, a moving picture data item having the highest resolution) from all the moving picture data items corresponding to the video title to be played back, and plays back the selected moving picture data item (block S113). After executing the block S113, the system controlling processor 100 proceeds to the block S117.

If the system controlling processor 100 determines that the operation mode of the AV player 10 is “the high-quality playback mode” (YES in block 114), it selects a moving picture data item of the highest image quality (for example, a moving picture data item having the highest resolution) from all the moving picture data items corresponding to the video title to be played back, and plays back the selected moving picture data item (block S115). After executing the block S115, the system controlling processor 100 proceeds to the block S117. If the charge remaining in the battery 104 is reduced to a very low level during the playback of the video title, the system controlling processor 100 switches the moving picture data item to be played back from the moving picture data item of the highest image quality (for example, a moving picture data item having the highest resolution) to the moving picture data item of the longest playback time.

If the system controlling processor 100 determines that the amount of charge remaining in the battery is equal to or lower than the predetermined value (NO in block S118), it determines whether there is a moving picture data item, which can be played back at lower power consumption as compared to the moving picture data item currently selected, in the plurality of moving picture data items corresponding to the video title currently under the playback (block S121).

If there is a moving picture data item that can be played back at lower power consumption as compared to the moving picture data item currently selected (YES in the block S121), the system controlling processor 100 determines whether the operation mode is an automatic power saving mode, in which the moving picture data is played back at a lowered resolution (block S122). If the system controlling processor 100 determines that the operation mode is the power saving mode (YES in block S122), it proceeds to the block S116 again.

If the system controlling processor 100 determines that there is not a moving picture data item that can be played back at lower power consumption as compared to the moving picture data item currently selected (NO in the block S121), or that the operation mode of the AV player 10 is not the automatic power saving mode (NO in the block S122), it continues the playback of the video title currently under the playback (the block S119).

As described above, in the first example of playback processing in this embodiment, the AV player 10 selects a moving picture data item that can be played back from the beginning to the end from the moving picture data items corresponding to the same video title as the currently played back video title, based on the amount of charge remaining in the battery 104 and the type of format. Then, the AV player 10 plays back the selected moving picture data item. Thus, the moving picture data item of the longest playback time is selected and the selected moving picture data item is played back without reducing or stopping the internal clock of the system controlling processor 100 in order to extend the battery lifetime of the AV player 10. As a result, the moving picture data can be continuously played back for a longer time without causing problems, such as frame omission. The AV player 10 also produces a contents list indicating estimated playback times based on the types of format and the amount of charge remaining in the battery 104. When a moving picture data item is to be played back, an optimum moving picture data item to continue the playback as long as possible is selected with reference to the generated contents list. The AV player 10 automatically selects an optimum moving picture data item to continue the playback as long as possible with reference to the contents list. At this time, the contents list, the playback available time of the selected moving picture data item, etc. may be displayed on the LCD panel 20. In this case, the user can observe the playback available time of the selected moving picture data item and also designate a moving picture data item other than that automatically selected from the displayed contents list.

During playback of moving picture data, if the amount of charge remaining in the battery becomes smaller than a predetermined threshold value, the AV player 10 can select a moving picture data item which allows the AV player to continuously playback moving pictures for a longer time as compared to the currently played back moving picture data item from all moving picture data items corresponding to the video title currently played back. Then, the AV player 10 can play back the selected moving picture data item. In other words, if the amount of charge remaining in the battery 104 is considerably reduced during the playback of a moving picture data item, the AV player 10 stops the playback of the moving picture data item and selects a moving picture data item, which corresponds to the same video title as the moving picture data item currently played back and which can be played back for a longer time. Then, the playback of the selected moving picture data item is started from the stopped position. Thus, during the playback of the video title, the moving picture data item of high quality can be switched to a moving picture data item of the same video title which allows the AV player to continuously play back moving pictures for a longer time. As a result, even if the charge remaining in the battery 104 is considerably reduced during the playback of the video title, the video title can be played back for a longer time as compared to the case of the moving picture data item currently played back.

Even if the amount of charge remaining in the battery 104 is a predetermined value or smaller, the AV player 10 can select a moving picture data item of the highest quality from all moving picture data items corresponding to the video title to be played back, and can play back the selected moving picture data item. As a result, even if the amount of charge remaining in the battery is very little, the user can view and listen to the video title to be played back in high quality within a certain period from the start of the playback. During the playback of the moving picture data item of the highest quality, the AV player 10 periodically checks the amount of charge remaining in the battery and the remainder of the playback time of the video title currently played back. If the amount of charge remaining in the battery is reduced to a predetermined value or smaller during the playback of a video title, the AV player 10 stops the playback of the moving picture data item, and selects a moving picture data item, which corresponds to the same video title as the moving picture data item currently played back and which can be played back for a longer time. Then, the AV player 10 starts the playback of the selected moving picture data item from the stopped position. Thus, the AV player switches the moving picture data item of high quality to a moving picture data item of the same video title which allows the AV player to continuously playback moving pictures for a longer time, and plays back the moving picture data item from the current playback position. As a result, the user can view and listen to the video title for a longer time in the remaining part of the video title.

If it is impossible to continuously drive the AV player 10 due to a power shortage in the battery 104 during playback of a moving picture data item, the AV player 10 stores the video title name of the moving picture data item currently played back, and playback position information. As a result, when the AV player 10 is activated again, it can play back the moving picture data item designated by the stored video title name from the position where the playback has been stopped, based on the playback position indicated by the playback position information.

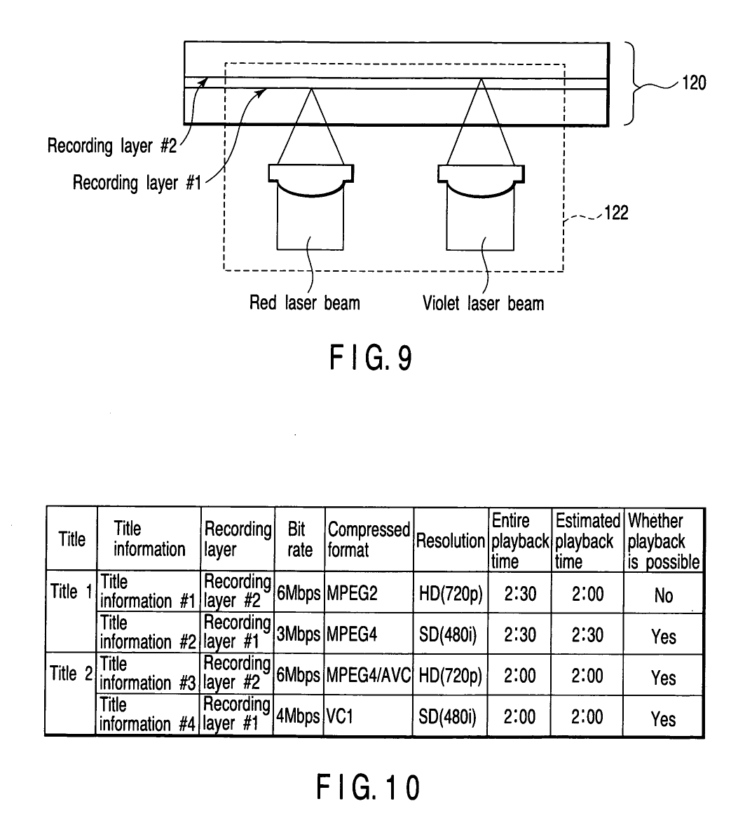

A second example of playback processing executed in the invention will be described with reference to the flowcharts shown in FIGS. 9 to 11. In the second example of playback processing, the AV player 10 plays back a moving picture content stored in a recording medium 120 having two recording layers. The recording medium 120 stores moving picture data items having different formats for each video title. FIG. 9 shows an example of a sectional structure of the recording medium 120. The recording medium 120 has two layers: a recording layer #1 and a recording layer #2. In the second example of playback processing, the AV player 10 switches between playback of a moving picture data item stored in the recording layer #1 and playback of a moving picture data item stored in the recording layer #2 from the moving picture data items stored in the recording disc having the two recording layers. The switching is determined on the basis of the charge remaining in the battery 104 and the type of format. More specifically, if the amount of charge remaining in the battery 104 is greater than a predetermined value, the AV player selects and plays back the moving picture data item stored in the recording layer #2 from moving picture data items corresponding to the video title to be played back. If the amount of charge remaining in the battery 104 is equal to or smaller than the predetermined amount, the AV player plays back the moving picture data item stored in the recording layer #1.

The recording layer #1 can be read by a normal DVD drive using, for example, a red laser beam. The recording layer #1 stores moving picture data items having a resolution of, for example SD, for each of the video titles. The recording layer #2 can be read by an HD DVD drive using, for example, a violet laser beam. The recording layer #2 stores moving picture data items having a resolution of, for example, HD, for each of the video titles.

The optical pickup 122 of the optical disc drive 30 is a DVD/HD DVD-compatible optical head. It can read either the recording layer #1 or the recording layer #2 by selectively using the red laser beam and the violet laser beam.

In this embodiment, a DVD/HD DVD-compatible recording disk and a DVD/HD DVD-compatible optical head are used. However, it is possible to use a recording medium having a recording layer #1 and a recording layer #2, both of which can be read by a violet laser beam, and an HD DVD optical head which can read the two recording layers in the recording medium.

A contents list in the second example of the playback processing will be described with reference to FIG. 10. As shown in FIG. 10, the contents list in the second example of the playback processing includes items “title”, “title information”, “recording layer”, “bit rate”, “compressed format”, “resolution”, “entire playback time”, “estimated playback time” and “whether playback is possible”, for each of the moving picture data items. Explanation of the items shown in FIG. 10 that are the same as those shown in FIG. 4 will be omitted. The item “recording layer” indicates a recording layer which stores a moving picture data item.

The recording medium 120 stores two moving picture data items corresponding to the video title 1 and two moving picture data items corresponding to the video title 2. The two moving picture data items corresponding to the video title 1 is a moving picture data item corresponding to title information #1 stored in the recording layer #2 and a moving picture data item corresponding to title information #2 stored in the recording layer #1. The two moving picture data items corresponding to the video title 2 is a moving picture data item corresponding to title information #3 stored in the recording layer #2 and a moving picture data item corresponding to title information #4 stored in the recording layer #1.

The two moving picture data items corresponding to the video title 1 (the moving picture data item corresponding to title information #1 and the moving picture data item corresponding to title information #2) are structured from one image source, the entire playback time of which is two hours and thirty minutes. The two moving picture data items corresponding to the video title 2 (the moving picture data item corresponding to title information #3 and the moving picture data item corresponding to title information #4) are structured from one image source, the entire playback time of which is two hours.

For example, the image picture data item corresponding to the title information #1 is an image picture data item having a type of format defined by the combination of the bit rate of 6 Mbps, the compressed format of MPEG2 and the resolution of HD standard. As for the moving picture data item corresponding to the title information #1, entire playback time is two hours and thirty minutes, whereas the estimated playback time is two hours. Therefore, the item “whether playback is possible” of the moving picture data item corresponding to the title information #1 is assigned the mark “No” by the system controlling processor 100.

The image picture data item corresponding to the title information #2 is an image picture data item having a type of format defined by the combination of the bit rate of 3 Mbps, the compressed format of MPEG4 and the resolution of SD standard. As for the moving picture data item corresponding to the title information #2, entire playback time is two hours, and the estimated playback time is also two hours. Therefore, the item “whether playback is possible” of the moving picture data item corresponding to the title information #2 is assigned the mark “Yes” by the system controlling processor 100.

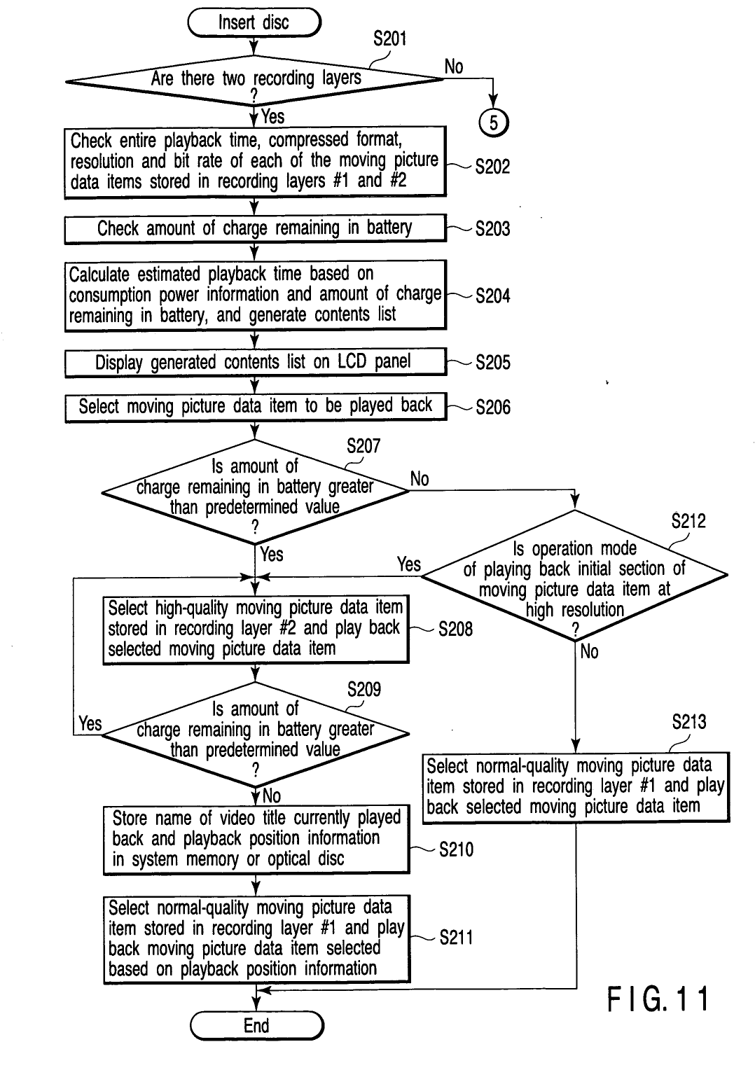

A second example of playback processing in this embodiment will now be described with reference to the flowcharts shown in FIG. 11. When the recording medium 120 is inserted in the optical disk drive 30, the system controlling processor 100 determines whether the inserted recording medium 120 has two recording layers (block S201). In the block S201, the optical pickup 122 irradiates the inserted recording medium 120 selectively with a red laser beam or a violet laser beam. If the radiated violet laser beam is reflected by the recording layer #2 of the recording medium 120, the system controlling processor 100 determines that the recording medium 120 has the recording layer #2. On the other hand, if the radiated violet laser beam is not reflected, the system controlling processor 100 determines that the recording medium 120 has only one recording layer #1 (NO in the block S201). In this case, the system controlling processor 100 proceeds to the block S102 in FIG. 6.

If the system controlling processor 100 determines that the recording medium 120 has the two recording layers (YES in the block S201), it obtains AV signals respectively from the recording layer #1 and the recording layer #2 of the recording medium 120, and checks the entire playback time and a type of format (bit rate, resolution and compressed format) of each of the moving picture data items (block S202). The system controlling processor 100 checks the amount of charge currently remaining in the battery 104 (block S203). The system controlling processor 100 calculates an estimated playback time of each moving picture data item based on the consumption power information and the checked amount of charge remaining in the battery, and generates a contents list based on the calculation results (block S204). The system controlling processor 100 displays the generated contents list on the LCD panel 20 (block S205). In the block S205, the system controlling processor 100 displays the estimated playback time and whether the playback is possible or not with respect to a moving picture data item corresponding to each of the video titles on a on-screen display (OSD) or the display panel 16 if necessary. The system controlling processor 100 selects a video title to be played back from a plurality of video titles (block S206). In the block S206, if the operation mode of the AV player 10 is an automatic selection mode, the system controlling processor 100 automatically selects the video title to be played back from the plurality of video titles. If the operation mode of the AV player 10 is a user selection mode, the system controlling processor 100 causes the LCD panel 20 to display a screen to select the video title to be played back from the plurality of video titles. The user can select the video title to be played back by operating the operation switch group 14.

Then, the system controlling processor 100 determines whether the amount of charge remaining in the battery 104 is greater than a predetermined value (block S207). If the system controlling processor 100 determines that the charge remaining in the battery 104 is greater than the predetermined value, for example, that the amount of charge is large enough to play back a moving picture data item of high image quality to the end (YES in the block S207), the system controlling processor 100 selects a high-quality moving picture data item stored in the recording layer #2 (a moving picture data item having resolution of, for example, HD) from the moving picture data items corresponding to the video title to be played back. Then, it plays back the selected moving picture data item (block S208).

On the other hand, if the system controlling processor 100 determines that the charge remaining in the battery 104 is not greater than the predetermined value, for example, that the amount of charge is large enough to play back a moving picture data item of high image quality to the end (NO in the block S207), the system controlling processor 100 determines whether the current operation mode of the AV player 10 is “the high-quality playback mode” (block S212). If the operation mode of the AV player 10 is determined not to be “the high-quality playback mode” (NO in the block S212), the system controlling processor 100 selects a normal-quality moving picture data item stored in the recording layer #1 (a moving picture data item having resolution of, for example, SD) from the moving picture data items corresponding to the video title to be played back. Then, it plays back the selected moving picture data item (block S213). If the operation mode of the AV player 10 is determined to be “the high-quality playback mode”, the system controlling processor 100 proceeds to the block S208, selects a moving picture data item of high quality stored in the recording layer #2 from the moving picture data items corresponding to the video title to be played back. Then, it plays back the selected moving picture data item.

Subsequently, the system controlling processor 100 checks again the amount of charge remaining in the battery 104 during playback of the moving picture data item, and determines whether the amount of charge remaining in the battery 204 is greater than the predetermined value (block S209). If the amount of charge remaining in the battery 204 is equal to or smaller than the predetermined value (NO in block S209), the system controlling processor 100 stores the name of the video title currently played back and the playback position information in the system memory 103 or the DVD-RAM (block S210). Then, the system controlling processor 100 selects a moving picture data item of a normal image quality stored in the recording layer #1 from the moving picture data items corresponding to the video title designated by the stored video title name based on the generated contents list. The system controlling processor 100 stops the playback of the moving picture data item of high quality, and starts playback of the selected moving picture data item from the playback position indicated by the stored playback position information (block S211).

As described above, according to the second example of the playback processing, when the amount of charge remaining in the battery 104 is equal to or smaller than the predetermined value, the AV player 10 selects a moving picture data item of normal quality stored in the recording layer #1, which corresponds to the same video title as that currently under the playback. Then, the AV player 10 plays back the selected moving picture data item. In other words, if the amount of charge remaining in the battery 104 is considerably reduced during the playback of a moving picture data item, the AV player 10 stops the playback of the moving picture data item and selects a moving picture data item, which corresponds to the same video title as the moving picture data item currently played back and which is stored in the recording layer #1. Then, the AV player 10 starts playback of the selected moving picture data item from the stopped position. Thus, during the playback of the video title, the moving picture data item of high quality stored in the recording layer #2 can be switched to a moving picture data item of normal quality of the same video title which is stored in the recording layer #1. Therefore, even if the charge remaining in the battery 104 is considerably reduced during the playback of the video title, the video title can be continuously played back by switching the moving picture data item currently played back to a moving picture data item of the same video title which can be played back for a longer time.

If the amount of charge remaining in the battery 104 is reduced to the predetermined value or smaller during the playback of the moving picture data item stored in the recording layer #2, the AV player 10 stops the playback of that moving picture data item and starts playback of the moving picture data item of the same video title stored in the recording layer #1 from the stopped position. In other words, if the amount of charge remaining in the battery 104 is reduced to the predetermined value or smaller, the AV player 10 stops the playback of the moving picture item currently played back, selects a moving picture data item of the same video title currently under playback, and starts playback of the selected moving picture data item from the stopped position.

In the embodiment described above, the moving picture data items corresponding to the video title are stored in the recording medium 120. However, they may be stored in, for example, the memory card 109. Further, although the video title currently under playback and the playback position information are recorded in the DVD-RAM or the like, they may be recorded in, for example, the memory card 109.

Moreover, the AV player 10 of the above embodiment generates a contents list and selects a moving picture data item to be played back based on the contents list. However, the AV player 10 may select a moving picture data item of a video title to be played back based on the types of format of the moving picture data items and the amount of charge remaining in the battery 104 that has been checked. For example, if the amount of charge remaining in the battery is greater than the predetermined value, the AV player 10 selects a moving picture data item of the highest image quality from the moving picture data items corresponding to the video title to be played back, and plays back the selected moving picture data item. If the amount of charge remaining in the battery is equal to or smaller than the predetermined value, the AV player 10 selects a moving picture data item having the longest estimated playback time from the moving picture data items corresponding to the video title to be played back, and plays back the selected moving picture data item. If the amount of charge remaining in the battery 140 is equal to or smaller than the predetermined value, the AV player 10 may select a moving picture data item of high quality in an initial section of the moving picture data item to be played back so that the section can be played back at a high resolution, and a moving picture data item that can be played back for a longer time in the remaining section of the moving picture data item.

All procedures of the playback processing described above are implemented by a computer program. Therefore, the same effects and advantages as those of the above embodiment can easily be obtained by applying the computer program to a conventional computer via a computer-readable recording medium.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A playback apparatus capable of playing back moving picture data from a recording disc of a two-layer structure including a first recording layer storing a moving picture data item having a first resolution and a second recording layer storing a moving picture data item having a second resolution, the playback apparatus comprising:
a battery to drive the playback apparatus; and
a processor to perform control of switching between playback of the moving picture data item stored in the first recording layer and playback of the moving picture data item stored in the second recording layer based on an amount of charge remaining in the battery.

2. The playback apparatus according to claim 1, wherein the processor plays back the moving picture data item having the first resolution when the amount of charge remaining in the battery is greater than a predetermined value, and executes switching to play back the moving picture data item having the second resolution when the amount of charge remaining in the battery is equal to or smaller than the predetermined value during playback of the moving picture data item having the first resolution.

3. The playback apparatus according to claim 2, wherein the processor stores information indicative of a playback stopped position at which playback of the moving picture data item having the first resolution is stopped, and starts playback of the moving picture data item having the second resolution from the playback stopped position based on the stored information.

4. The playback apparatus according to claim 1, wherein the processor estimates playback time in which each of the moving picture data item having the first resolution and the moving picture data item having the second resolution can be played back by power supplied from the battery, based on the amount of charge remaining in the battery, and causes an estimation result to be displayed on a display screen of the playback apparatus.

5. The playback apparatus according to claim 1, wherein:
the first resolution is higher than the second resolution; and
the processor first plays back the moving picture data item having the first resolution and switches the moving picture data item having the first resolution to the moving picture data item having the second resolution during playback of the moving picture data item having the first resolution.

6. A playback method applied to a playback apparatus capable of playing back moving picture data from a recording disc of a two-layer structure including a first recording layer storing a moving picture data item having a first resolution and a second recording layer storing a moving picture data item having a second resolution, the method comprising:
checking an amount of charge remaining in a battery which drives the playback apparatus; and
controlling switching between playback of the moving picture data item stored in the first recording layer and playback of the moving picture data item stored in the second recording layer based on the amount of charge remaining in the battery.

7. The playback method according to claim 6, wherein the controlling includes playing back the moving picture data item having the first resolution when the amount of charge remaining in the battery is greater than a predetermined value, and executing switching to play back the moving picture data item having the second resolution when the amount of charge remaining in the battery is equal to or smaller than the predetermined value during playback of the moving picture data item having the first resolution.

8. The playback method according to claim 7, wherein the controlling includes storing information indicative of a playback stopped position at which playback of the moving picture data item having the first resolution is stopped, and starting playback of the moving picture data item having the second resolution from the playback stopped position based on the stored information.

9. The playback apparatus according to claim 6, wherein the controlling includes estimating playback time, in which each of the moving picture data items having the first resolution and the second resolution can be played back by power supplied from the battery, based on the amount of charge remaining in the battery, and causing an estimation result to be displayed on a display screen of the playback apparatus.

10. The playback apparatus according to claim 6, wherein:
the first resolution is higher than the second resolution; and
the controlling includes first playing back the moving picture data item having the first resolution and switching the moving picture data item having the first resolution to the moving picture data item having the second resolution during playback of the moving picture data item having the first resolution.
